(19) United States
(12) Patent Application Publication
(10) Pub. No.: US 2023/0373712 A1
(43) Pub. Date: Nov. 23, 2023

(54) ULTIMATE GARBAGE CAN WITH INBUILT LINER ROLL COMPARTMENT

(71) Applicant: CORNELIUS NUCKOLS, CHEVIOT, OH (US)

(72) Inventor: CORNELIUS NUCKOLS, CHEVIOT, OH (US)

(21) Appl. No.: 18/197,826

(22) Filed: May 16, 2023

Related U.S. Application Data
(60) Provisional application No. 63/342,733, filed on May 17, 2022.

(51) Int. Cl. B65F 1/06

(52) U.S. Cl. CPC B65F 1/062; B65F 1/1473

(57) ABSTRACT

The present invention discloses an improved garbage can which has an inbuilt liner roll compartment under its bottom, configured to place and hold a can liner roll to replace effortlessly and continuously a used can liner with a fresh can liner pulled up from under the bottom of the garbage can, without creating any messes, leakages, and spills. The garbage can supplies the fresh can liners from the liner roll compartment through a slotted hole provided at the bottom of the garbage can. The main purpose of the present invention is to provide the garbage can that facilitates an easier, cleaner, more sanitary, and more convenient can liner replacement task.

### CROSS-REFERENCE TO RELATED APPLICATIONS

This application claims the benefit of U.S. Provisional Application No. 63/342,733, filed on May 17, 2022.

### FIELD OF THE INVENTION

The present invention relates primarily to a garbage can. More particularly, the present invention pertains to a unique and improved garbage can which has an inbuilt liner roll compartment underneath the bottom, designed particularly to place and hold a can liner roll in order to allow an easy removal of a used or filled can liner and simultaneously applying a fresh can liner, without causing any messes, leakages, spills.

### BACKGROUND OF THE INVENTION

A good hygiene practice is as important as anything for health as well as environment. No home, office, factory, public building, public garden, recreation area, or nature reserve can be kept clean without a number of garbage cans wherein people can dispose the innumerous waste items generated as a result of eating, drinking, smoking and other day-to-day activities. It is a usual practice to provide the garbage cans with disposable can liners so that when a can liner inside the garbage can is full, the filled can liner is removed and a fresh can liner is installed, hence, to keep the garbage can clean and ready for reuse. However, removing the used can liner and installing the fresh can liner are a kind of insanitary tasks. Generally, a person, such as, a janitor has to remove the filled can liners every time they get loaded with trash, and by the time the janitor installs the fresh can liner, someone has thrown the waste things away before the fresh can liner was put in the can. As a result, the janitor has to reach in the bottom of a nasty dirty can to take out the trash and put on the fresh can liner.

Various prior arts have been disclosed in order to attempt and solve the aforesaid problems as this is a crowded field, but suffer from one or more other problems discussed below.

A prior art WO2001008985A9 to Borgward et al. describes a bag device for the insertion of bags into a container, wherein the bag device contains a device for holding the bags which can be separated from the endless material at predefined perforation locations and are prefabricated as hose-like endless material. The endless material is held in the roller holding device and can be moved towards the upper edge of the container by means of a traction force that is oriented towards the upper side.

Another prior art CN101823608A to Tan Quanqing describes a bag containing basin which is arranged on the top of a basin post around a center post, a support bar is movably connected on a base frame, the top end of an arc-shaped framework connected with the other end of the support bar is provided with a latch hook, the outer margin is provided with an arc-shaped case, a pedal connecting rod consisting of a U-shaped fork, a connecting rod and a pedal plate is arranged under the base frame, and a telescopic spring is arranged on the center post. After rubbish is thrown into the rubbish bin, the pedal plate is released, and a plastic bag is automatically sealed. However, the bin of the Tan is not disclosing anything about replacement of the bag without creating any messes and leakages.

Still another prior art FR2701250A1 to Jia Ying describes a device for guiding, opening and automatic replacement of bin bags. The system consists of a conventional waste bin having two orifices via which a roll of plastic bags is introduced, which is inserted over a support bar. When the user removes a full bag, the new one is automatically guided and opened by the guides which slide in four curved rails provided for this purpose. It is then blocked over four pivots with springs located at the top of each rail.

Still another prior art US20120087600A1 to Ali Bahojbalmasi describes a car trash bag which comprises lower frame which fixes by headrest and always is in place and holds trash bag, upper lid which is an open top lid and entangles trash bag, and disposable trash bag. When the trash bag becomes full of garbage, the upper lid will be raised by removing it from lower frame and trash bag gets out from underside and a new trash bag will be replaced.

Still another prior art U.S. Pat. No. 5,322,179A to Chi-En Ting describes a garbage can having an outer can, an inner can to be contained and hung in the outer can normally closed by two half caps being opened by a lever with a pedal stepped down to open the two half caps outward with an adhesive bar thereof closing and opening an open upper end of a garbage bag adhered to the bars simultaneously, and a garbage bag roll being stored below the inner can on the bottom of the outer can supplying garbage bags one by one continuously through a slot in the bottom of the inner cap.

Although there are many solutions available in the market to automatically replace the can liners inside the garbage can itself, they are quite complex in nature and do not adequately solve or provide a viable solution to the current problems associated with the conventional garbage cans and replacement of the can liners. The conventional arts do not disclose about any integral part of the garbage can, but they disclose a device that separately fits around the garbage can, or hung from the side of the garbage can, or removably sat in the bottom of the garbage can. However, sitting in the bottom of the garbage can does not prevent spillage from going inside the device. Moreover, the device could be misplaced or lost since it is not a part of the garbage can itself. Further, the device may be made up of a non-plastic material which would have to be washed if dirty, thus not be able to use again. The device that sits in the bottom of the garbage can may be sealed hence cannot be opened to check whether it is on the last bag. Other locations disclosed for the device installation are recited around garbage areas only which may make it messy. The existing solutions, therefore, render incompatible device with the complex as well as inefficient installations.

The applicant is unaware of any such can liner replacement means which is an integral part of the garbage can itself. More specifically, there is no such garbage can disclosed in the prior arts that has an inbuilt liner roll compartment under the bottom, designed particularly to place and hold a can liner roll in order to allow an easy removal of the used or filled can liner and simultaneously applying the fresh can liner pulled up from under the bottom of the garbage can, without causing any messes, leakages, spills, and busted or torn liners.

The aforesaid conventional can liner replacement apparatuses encounter various problems and are provided with quite a complicated configuration. On the other hand, the present invention discloses a practical solution that provides a unique and improved garbage can with the inbuilt liner roll compartment under the bottom for the continuous replacement of the can liners. Therefore, they are clearly differentiable from the present invention both in utility and design. The unique characteristics and features of the present invention are unrepresented within the conventional can liner replacement apparatuses. Hence, the present invention has been disclosed to provide solutions to the aforementioned needs, and to resolve the aforementioned deficiencies in the conventional apparatuses.

### SUMMARY OF THE INVENTION

The present invention concerns improvements in and relating to a garbage can. The present invention discloses a simple, yet unique and improved garbage can, which has an inbuilt liner roll compartment integrated under its bottom, configured to place and hold a can liner roll to effortlessly and continuously replace a used can liner with a fresh can liner pulled up from under the bottom of the garbage can, without creating any messes, leakages, spills, and busted or torn can liners.

The primary objective of the present invention is to provide a garbage can with inbuilt liner roll compartment which addresses the needs which were not fulfilled by the conventional can apparatuses.

Another objective of the present invention is to provide a garbage can which has a liner roll compartment that is located under bottom of the garbage can.

Still another objective of the present invention is to provide a garbage can which encloses and holds a can liner roll into a liner roll compartment to continuously supply a fresh can liner from inside the garbage can through a slotted hole provided at bottom of the garbage can.

Still another objective of the present invention is to provide a garbage can which prevents a can liner roll from being exposed to garbage areas or any leakages from torn can liners.

Still another objective of the present invention is to provide a garbage can which drains out fluids or small debris that may be accumulated in bottom.

Still another objective of the present invention is to provide a garbage can which has a liner roll compartment that is easily accessible in order to ensure timely refilling of a can liner roll.

Still another objective of the present invention is to provide a garbage can which prevents accumulation of excess trash at bottom of the garbage can.

Still another objective of the present invention is to provide a garbage can which stores at least one can liner roll in a liner roll compartment that is adapted to keep the can liner roll dry and clean.

Still another objective of the present invention is to provide a garbage can that facilitates an easier, cleaner, more sanitary, and definitely more convenient can liner replacement task.

Still another objective of the present invention is to provide a garbage can which is designed to provide safe as well as time efficient solution for the people working with trash all day.

The summary is provided to introduce representative objectives of the present invention in a simplified form that are further described below in the detailed description. This summary is not intended to identify key features or essential features of the present subject matter, nor is it intended to be used in any way that would limit the scope of the present subject matter.

### BRIEF DESCRIPTION OF DRAWINGS

Other objects, advantages and novel features of the invention will become apparent from the following detailed description of the present embodiment when taken in conjunction with the accompanying drawings. These figures are not intended to limit the scope of the present invention but rather illustrate certain attributes thereof.

FIG. 1 illustrates a perspective view of a garbage can with inbuilt liner roll compartment, according to an embodiment of the present invention.

FIG. 2 illustrates an exploded view of a garbage can with inbuilt liner roll compartment, according to an embodiment of the present invention.

FIG. 3 illustrates a perspective view of an inbuilt liner roll compartment in a closed state, according to an embodiment of the present invention.

FIG. 4 illustrates a perspective view of an inbuilt liner roll compartment of FIG. 3 in an open state, according to an embodiment of the present invention.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

The foregoing disclosure has broadly outlined the features and technical advantages of the present disclosure in order that the description of the disclosure that follows may be better understood. It should be appreciated by those skilled in the art that the conception and specific embodiment disclosed may be readily utilized as a basis for modifying or designing other structures for carrying out the same purposes of the present disclosure. The novel features which are believed to be characteristic of the disclosure, both as to its organization and method of operation, together with further objects and advantages will be better understood from the following description.

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or carried out in a variety of ways. It is to be understood that the phraseology and terminology employed herein is for the purpose of description and not of limitation.

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

It is to be understood that the terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

It is to be understood that the elements preceded by “comprises . . . a”, “has . . . a”, “includes . . . a”, “contains . . . a” does not, without more constraints, preclude the existence of additional identical elements in the process, method, article, or apparatus that comprises, has, includes, contains the elements.

It is to be understood that the terms “a” and “an” are defined as one or more unless explicitly stated otherwise herein.

It is to be understood that a device or structure that is “configured” in a certain way is configured in at least that way, but may also be configured in ways that are not listed.

### Definitions

The term “garbage can” used herein refers to any receptacle or container that holds any waste matter that has been thrown away.

The term “user” used herein refers to any person who needs to replace a can liner in a garbage can, such as, but not limited to, a janitor, a homemaker, a general public.

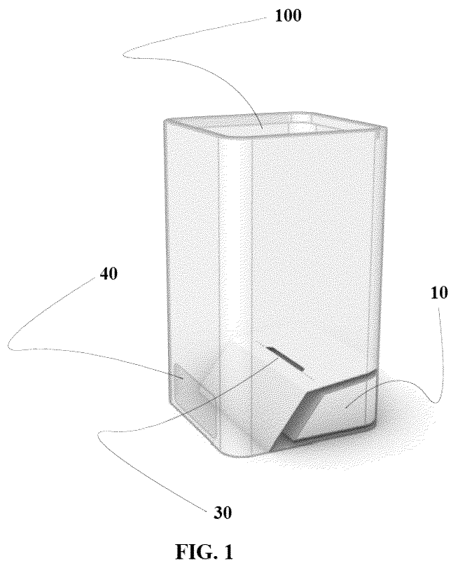

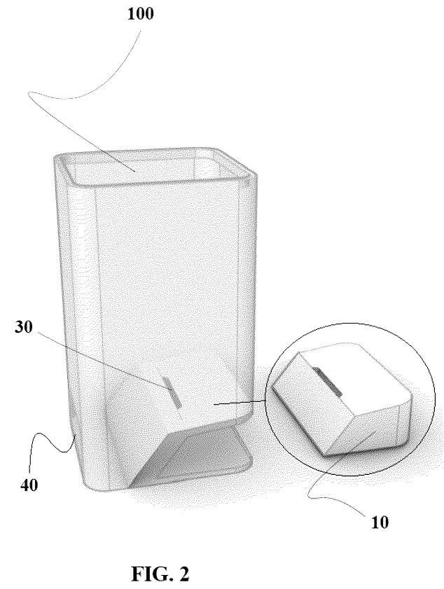

According to an embodiment of the present invention, a perspective view of a garbage can 100 with inbuilt liner roll compartment is shown in FIG. 1. Turning to FIG. 1, the garbage can 100 comprising: a liner roll compartment 10 securely built underneath a bottom of the garbage can 100, configured to store and hold a can liner roll 20, and also adapted to keep the can liner roll 20 dry and clean; a slotted hole 30 provided in the bottom, configured to pull up a fresh can liner from the can liner roll 20 whenever needed; a drain passage 40 with a stopper, provided at the bottom in a side wall of the garbage can 100, to drain out fluids or small debris from the bottom which may be accumulated if a can liner in use get torn or leaked; and a plurality of wheels under the bottom, adapted to move the garbage can 100 from one place to another. An exploded view of the garbage can 100 with inbuilt liner roll compartment is shown in FIG. 2, wherein the liner roll compartment 10 is clearly visible.

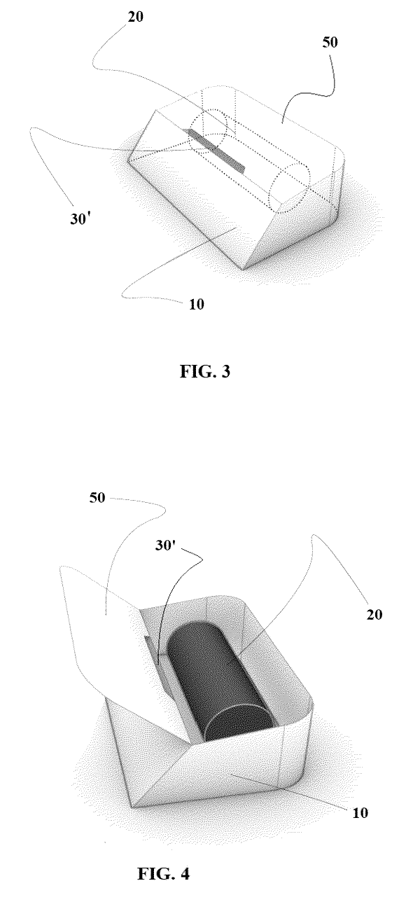

According to an embodiment of the present invention, a perspective view of the liner roll compartment 10 in closed state is shown in FIG. 3. Referring to FIG. 3, the liner roll compartment 10 comprises a slotted hole 30′ which is configured to align with the slotted hole 30 and adapted to pull up the fresh can liner from inside of the can liner roll 20 whenever needed; and a flap closure 50 configured to securely close the liner roll compartment 10 hence to store and keep the can liner roll 20 dry and clean. Further, the flap closure 50 facilitates easy access to the liner roll compartment 10, thereby a user can open the liner roll compartment 10 at any time to ensure timely refilling of the can liner roll 20.

According to one embodiment of the present invention, a perspective view of the liner roll compartment 10 in open state is shown in FIG. 4, wherein the flap closure 50 is lifted up therefrom to easily access the liner roll compartment 10. Also, the can liner roll 20 is shown placed inside the liner roll compartment 10.

According to one embodiment of the present invention, the drain passage 40 can be opened and closed, hence, to keep the bottom of the garbage can 100 clean. If the user needs to spray out the garbage can 100, then the user could rest assure that the excess debris and fluids would be drained out from the garbage can 100 via the drain passage 40. However, with the constant lining of the garbage can 100 of the present invention, landing of the excess trash at the bottom of the garbage can 100 can be prevented.

According to one embodiment of the present invention, the garbage can 100 prevents the user from having to keep the garbage can 100 and the can liner roll 20 in two separate places. The garbage can 100 will store at least one can liner roll in the liner roll compartment 10 underneath the bottom that stays dry and clean. The can liner dispenses from the bottom of the garbage can 100 via the slotted hole 30 and pulls up to top and lines the garbage can 100. As the can liner get filled and pulled up entirely by the user for disposal, another fresh clean liner pulls up through from the bottom, and lines the garbage can 100 at the same time.

The garbage can 100 of the present invention with the liner roll compartment 10 is highly advantageous and well applied as compared to the conventional can apparatuses. The present invention as disclosed above describes an effective way to keep the liners clean and sanitary and to avoid mess in the liner roll compartment 10. The simple and unique design of the garbage can 100 serve a desirable function of replacing the can liners without any mess. The present invention allows continuous can liners inside the garbage can 100 itself from the liner roll compartment 10 via the slotted hole 30′ and the slotted hole 30 provided at the bottom of the garbage can 100. The slotted holes 30, 30′ dispense the fresh liners one by one continuously. In this way, the user will be able to remove the trash-filled liner and apply the fresh liner each time effortlessly.

The present invention makes the liner replacement task more convenient and time efficient. For instance, in large stadiums or factories, etc. where the garbage cans are constantly being filled, the present invention in such cases, makes it easier and saves time for the janitors and garbage removal teams to remove the trash-filled liners quickly and reline the fresh liner in seconds to keep the flow going in every business. Also, restaurant workers don't have the time in the middle of a rush to pull trash, take it out, come back and line the can. By implementing the garbage can of the present invention, they can pull the trash-filled liner and line the can with the fresh liner at the same time.

The present invention is much more sanitary and safer for the people working with trash all day because it provides a convenient and time saving way to pull up the used liners through the bottom in order to render ease and comfort to change the liners and keep the task moving without slowing down. The present invention can be majorly applicable to janitorial work, for example, a team of individuals that have to empty multiple trash cans in a stadium, cafeteria, industrial buildings, factories, etc. The present invention, hence, gives them the continuous motion of emptying the cans and refilling with the fresh liners all in one move. Most importantly, the present invention described herein aims to provide a solution that is practical, which can be implemented into a viable commercial success.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The invention has been explained in relation to specific embodiments. It is inferred that the foregoing description is only illustrative of the present invention, and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

1. A garbage can, said garbage can comprising:
a liner roll compartment securely built underneath a bottom of said garbage can, configured to store and hold a can liner roll;
a first slotted hole provided in said bottom, configured to pull up a fresh can liner from said can liner roll whenever needed;
a drain passage with a stopper, provided at said bottom in a side wall of said garbage can, to drain out fluids or small debris from said bottom; and
a plurality of wheels under said bottom, adapted to move said garbage can from one place to another.

2. The garbage can of claim 1, wherein said liner roll compartment comprises a second slotted hole which is configured to align with said first slotted hole and adapted to pull up said fresh can liner from inside of said can liner roll whenever needed.

3. The garbage can of claim 1, wherein said liner roll compartment comprises a flap closure configured to securely close said liner roll compartment hence to store and keep said can liner roll dry and clean.

4. The garbage can of claim 3, wherein said flap closure facilitates easy access to said liner roll compartment, thereby a user can open said liner roll compartment at any time to ensure timely refilling of said can liner roll.

5. The garbage can of claim 1, wherein said liner roll compartment is further configured to prevent said can liner roll from being exposed to garbage areas or any leakages from torn can liners.

6. The garbage can of claim 1, wherein said drain passage can be opened and closed, hence, to keep said bottom of said garbage can clean.

7. The garbage can of claim 1, wherein at least one can liner roll is stored in said liner roll compartment underneath said bottom that stays dry and clean.

8. The garbage can of claim 1, wherein said fresh can liner dispenses from said bottom via said first slotted hole and pulls up to top and lines said garbage can at the same time when user pulls up a filled can liner for disposal.
